(19) United States
(12) Patent Application Publication
(10) Pub. No.: US 2005/0243550 A1
(43) Pub. Date: Nov. 3, 2005

(54) LED bulb

(76) Inventor: Albert Stekelenburg, Taipei (TW)

Correspondence Address: BRUCE H. TROXELL, SUITE 1404, 5205 LEESBURG PIKE, FALLS CHURCH, VA, 22041, US

(21) Appl. No.: 10/834,926

(22) Filed: Apr. 30, 2004

(51) Int. Cl. F21V 1/00

(52) U.S. Cl. 362/240; 362/650; 362/800; 362/361

(57) ABSTRACT

The present invention is relating to a LED bulb, especially the LED bulb with separable globe. Thereby, the globe can be changeable in different colors and shapes.

### BACKGROUND OF THE INVENTION

The present invention is relating to a LED bulb, especially the LED bulb with separable globe. By the way, said LED bulb can be change the globe in different colors and/or shapes alternatively.

The LED bulb is a conventional product which well-used in many circumstances. Normally, through the design of electric circuit, it can be maintain lighting as normal lamp, meanwhile, it also can be designed as flashing.

U.S. Pat. No. 6,150,774 (Mueller et al) disclosed a multi-color LED lighting apparatus and method. Through the addressable controller, providing the means for receiving the data corresponding to the alterable address and indicative of predefined portion of the timing circle.

However, at present, the globe of the LED bulb normally processed with the base of LED array integrally and usually is unseperable. Therefore, the globe of LED bulb is restricted in the predefined color and shape.

### SUMMARY OF THE INVENTION

However, the major purpose of the present invention is to provide a LED bulb with separable globe enable the bulb changeable in color and shape.

In order to achieve the purpose of globe changeable, the present invention provides a separate top portion and base portion of globe and connected by connecting means therebetween.

### BRIEF DESCRIPTION OF THE DRAWINGS

FIG. 1 is the prospective view of one of the embodiment.

FIG. 2 is the explore view of the present invention.

FIG. 3 is the sectional view of the assembly of the present invention.

FIG. 4 is the prospective view of the other shape of upper globe.

FIG. 5 is the prospective view of the upper globe in other shape.

### DETAILED DESCRIPTION OF THE PREFERRED EMBODIMENT

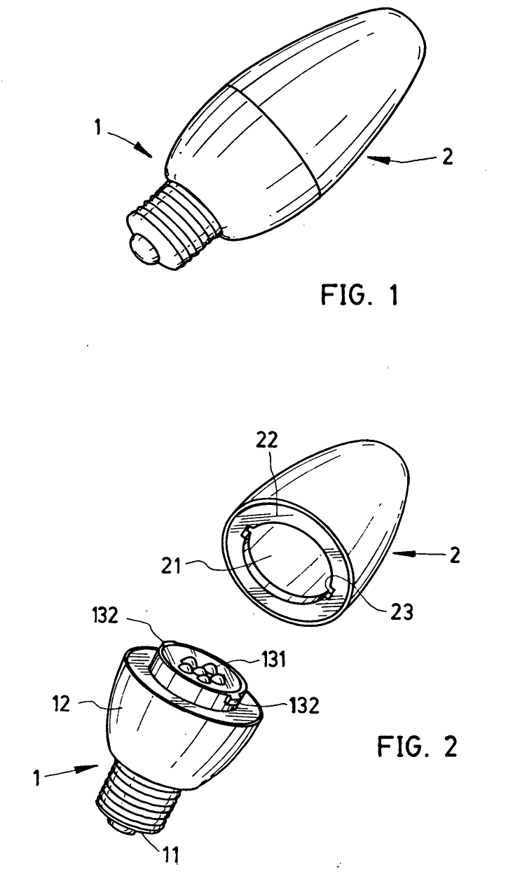

As refer to FIG. 1 and FIG. 2, basically, the LED bulb of the present invention comprises a base portion 1 and an upper globe 2.

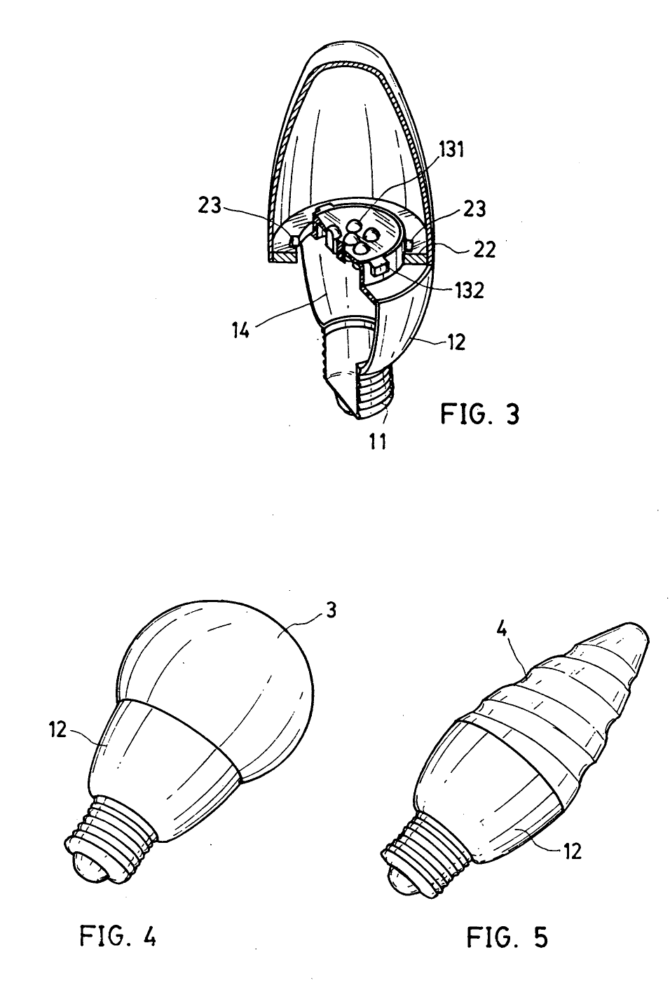

The base portion includes a bulb connector 11 and a lower globe 12. Said lower globe 12 further provides at least one LED 131 located in a base 13 which electrically connect to the circuit board (not disclosed) which received within the space 14 inside of lower globe (refer to FIG. 3). The feature of the present invention distinguishing with the convention art is that the lower globe further provides the lower globe connecting means 132 enable connect said lower globe 12 with upper globe 2. According to the preferred embodiment, the lower globe connecting means 132 can is tenons extending outwardly from the wall of base 13. Actually, it can be other simply way such as the tenon or groove provided in the circumference of lower globe 12.

Refer to FIG. 2 and FIG. 3, the upper globe is a hollow shell with a central hole 21 on the bottom. The central hole 21 is formed by the bottom plate 22 connecting with the bottom of inner wall of said upper globe 2. Corresponding to said lower globe connecting means, provides the upper globe connecting means 23 respectively. According to the embodiment, said upper globe connecting means 23 is groove or crack which matching with said lower globe connecting means 132. Actually, said upper globe connecting means 23 can be other structures enable to connect with said lower globe connecting means 132.

Refer to FIG. 3, when assembly, the lower globe connecting means 132 can be connected with said upper globe connecting means to form a LED bulb.

Therefore, refer to FIG. 4 and FIG. 5, based on the same and existing lower globe 12, the upper globe 3, 4 can be changeable in different colors and shapes. By the way, the shapes and color of LED bulb of the present invention will be more versatile than the conventional LED. This is a remarkable improvement on conventional LED bulb.

Although the present invention has been explained in relation to its preferred embodiment, it is to be understood that many other possible modifications and variations can be made without departing from the spirit and scope of the invention as hereinafter claimed.

1. A LED bulb which comprises:
a base portion which comprising a bulb connecter and lower globe portion connected thereof, said lower globe portion having a base which further providing at least one LED; said LED electrically connected with a electric board which received in the space inside the lower globe portion; said base further providing lower globe connecting means;
a upper globe portion which dimensional corresponding to said lower globe portion, on the bottom of said upper globe portion providing a central hole formed by bottom plate connect with inner bottom wall of said upper globe portion; said upper globe portion further providing upper globe connecting means corresponding to said lower globe connecting means respectively to enable separable connecting each other.

2. A LED bulb as claimed in claim 1, wherein said lower glove connecting means is tenon and said upper globe connecting means is crack.

3. A LED bulb as claimed in claim 1, wherein said lower globe connecting means is the groove around the outline of the upper surface and the upper globe connecting means is protrusion respectively.
